(19) United States
(12) Patent Application Publication
(10) Pub. No.: US 2014/0169236 A1
(43) Pub. Date: Jun. 19, 2014

(54) FEED FORWARD SIGNAL CANCELLATION

(71) Applicant: Kumu Networks, Santa Clara, CA (US)

(72) Inventors: Jung-Il CHOI, Sunnyvale, CA (US); Steven HONG, Sunnyvale, CA (US); Mayank JAIN, Sunnyvale, CA (US); Sachin KATTI, Stanford, CA (US); Philip LEVIS, San Francisco, CA (US); Jeff MEHLMAN, Sunnyvale, CA (US)

(73) Assignee: Kumu Networks, Santa Clara, CA (US)

(21) Appl. No.: 14/106,664

(22) Filed: Dec. 13, 2013

Related U.S. Application Data
(60) Provisional application No. 61/736,726, filed on Dec. 13, 2012.
(60) Provisional application No. 61/876,663, filed on Sep. 11, 2013.

(51) Int. Cl. H04L 5/14

(52) U.S. Cl. CPC H04L 5/1461
USPC 370/278

(57) ABSTRACT

A circuit that cancels a self-interference signal includes, in part, a pair of signal paths that are substantially in phase, each of which paths includes a passive coupler, a delay element and a variable attenuator. The circuit further includes, in part, a first group of P signal paths each of which is substantially in phase with the pair of paths, and a second group of M signal paths each of which is substantially out-of-phase relative to the pair of signal paths. Each of the P and M signal paths includes a delay element and a variable attenuator. Furthermore, (P−1) signal paths of the first group of P signal paths, and (M−1) signal paths of the second group of M signal paths include a passive coupler. Optionally, each of the M signal paths is optionally 180° out-of-phase relative to the pair of signal paths.

### CROSS-REFERENCES TO RELATED APPLICATIONS

The present application claims benefit under 35 §U.S.C. 119(e) of U.S. Provisional Patent Application No. 61/736,726, filed Dec. 13, 2012, entitled “FEED FORWARD SIGNAL CANCELLATION”, and U.S. Provisional Patent Application No. 61/876,663, filed Sep. 11, 2013, entitled “CANCELLATION CIRCUIT WITH VARIABLE DELAY AND AMPLIFIER” the contents of which are incorporated herein by reference in their entirety.

### FIELD OF THE INVENTION

The present invention relates to wireless communication, and more particularly to a full duplex wireless communication system.

### BACKGROUND OF THE INVENTION

A wireless system often operates in a half-duplex mode to either transmit or receive data at any given time. A device operating in a full-duplex mode may simultaneously transmit and receive data. However, the simultaneous transmission and reception of data are carried out over different frequencies. For example, a full-duplex cell phone uses a first frequency for transmission and a second frequency for reception. As is well known, using the same frequency for simultaneous transmission and reception in a conventional wireless system results in significant amount of self-interference at the receiver thereby rendering the system ineffective in receiving the desired signal.

### BRIEF SUMMARY OF THE INVENTION

A circuit, in accordance with one embodiment of the present invention, includes, in part, a first signal path, a second signal path, a first group of P signal paths and a second group of M signal paths. The first signal path includes, in part, a passive coupler, a delay element and a variable attenuator. The second signal path includes, in part, a passive coupler, a delay element and a variable attenuator. The second signal path is substantially in phase with the first signal path. The first group of P signal paths are substantially in phase with the first and second signal paths. Each of the first group of P signal paths includes, in part, a delay element and a variable attenuator. P−1 signal paths of the first group of P signal paths include a passive coupler. The second group of M signal paths each are substantially out-of-phase relative to the first and second signal paths. Each of the second M signal paths includes, in part, a delay element and a variable attenuator. M−1 signal paths of the second group of M signal paths include a passive coupler. Each of M and P is an integer equal to or greater than one.

In one embodiment, the circuit further includes, in part, at least one antenna for receiving or transmitting a signal. In one embodiment, each of the first signal path, the second signal path, the first group of P signal paths and the second group of M signal paths is adapted to receive a sample of a transmit signal and generate a delayed and weighted sample of the transmit signal. In one embodiment, the circuit further includes, in part, a control block adapted to vary an attenuation level of the variable attenuators disposed in the first signal path, the second signal path, the first group of P signal paths and the second group of M signal paths. The circuit further includes, in part, a combiner adapted to combine the delayed and weighted samples of the transmit signal to generate a first signal representative of a self-interference signal. The circuit further includes, in part, a combiner/coupler adapted to subtract the first signal from the received signal.

In one embodiment, the delay element disposed in the first signal path generates a delay shorter than the arrival time of a second sample of the transmit signal at the combiner/coupler, and the delay element disposed in the second signal path generates a delay longer than the arrival time of the second sample of the transmit signal at the combiner/coupler. In one embodiment, the first signal path, the second signal path, the first group of P signal paths and the second group of M signal paths form P/2+M/2+1 associated pairs of paths. The delays generated by the delay elements of each associated pair of delay paths form a window within which the second sample of the transmit signal arrives at the combiner/coupler.

In one embodiment, the circuit further includes, in part, a controller adapted to determine the attenuation levels of the variable attenuators in accordance with values of intersections of an estimate of the self-interference signal and P+M+2 sinc functions centered at boundaries of the P/2+M/2+1 windows. In one embodiment, a peak value of at least a subset of the P+M+2 sinc functions is set substantially equal to an amplitude of the estimate of the self-interference signal. In one embodiment, the circuit further includes, in part, a splitter adapted to generate the sample of the transmit signal from the transmit signal. In one embodiment, the circuit further includes, in part, an isolator having a first port coupled to the antenna, a second port coupled to a transmit line of the circuit, and a third port coupled to a receive line of the circuit. In one embodiment, the isolator is a circulator.

A method of reducing the self-interference signal in a communication system, in accordance with one embodiment of the present invention includes, in part, delivering a first portion of a first sample of a transmit signal to a first passive coupler to generate a first signal portion, generating a first signal defined by a delayed and weighted sample of the first signal portion, delivering a second portion of the sample of the transmit signal to a second passive coupler to generate a second signal portion, generating a second signal defined by a delayed and weighted sample of the second signal portion, generating a first group P signals each being substantially in phase with the first and second signals and each defined by a different delayed and weighted sample of either the first signal portion or the second signal portion, generating a second group of M signals each being substantially out-of-phase relative to the first and second signals and each defined by a different delayed and weighted sample of either the first signal portion or the second signal portion, and combining the first signal, the second signal, the first group of P signals and the second group of M signals to generate a combined signal representative of the self-interference signal.

The method, in accordance with one embodiment of the present invention, further includes, in part, receiving a second sample of the transmit signal via an antenna, and combining/coupling the combined signal with the second sample of the transmit signal received via the antenna. In one embodiment, the method further includes, in part, setting the delay of the first signal to a value less than the arrival time of the second sample of transmit signal at the antenna, and setting the delay of the second signal to a value greater than the arrival time of the second sample of the transmit signal at the antenna.

In one embodiment, the method further includes, in part, forming P/2+M/2+1 associated time windows defined by the delays of the first signal, the second signal, the first group of P signals, and the second group of M signals, and selecting the delays of the first signal, the second signal, the first group of P signals, and the second group of M signals such that the arrival time of the second sample of the transmit signal at the antenna falls within each of the P/2+M/2+1 time windows. The method further includes, in part, determining the weights of the first signal portion and the second signal portion in accordance with values of intersections of an estimate of the self-interference signal and P+M+2 sinc functions centered at boundaries of the P/2+M/2+1 time windows.

In one embodiment, the method further includes, in part, setting a peak value of at least a subset of the P+M+2 sinc functions substantially equal to an amplitude of the estimate of the self-interference signal. In one embodiment, the method further includes, in part, receiving the first sample of the transmit signal from a splitter. In one embodiment, the method further includes, in part, delivering a second portion of the transmit signal to an isolator, and delivering the transmit signal from the isolator to the antenna. In one embodiment, the isolator is a circulator.

A signal cancellation circuit, in accordance with one embodiment of the present invention, includes, in part, N signal paths each of which is either in-phase or 180° out-of-phase relative to other (N−1) signal paths. Each of at least a subset of the N signal paths includes, a passive coupler, a delay element and a variable attenuator, wherein N is an integer greater than one.

### BRIEF DESCRIPTION OF THE DRAWINGS

FIG. 1 is a simplified block diagram of a full-duplex wireless communication system, in accordance with one embodiment of the present invention.

FIG. 2 is a simplified block diagram of a full-duplex wireless communication system, in accordance with one embodiment of the present invention.

FIG. 3 is a simplified block diagram of a full-duplex wireless communication system, in accordance with one embodiment of the present invention.

FIG. 4 shows first and second windows each defined by the delays of different pairs of associated paths of the self-interference cancellation circuit of FIG. 3, in accordance with one embodiment of the present invention.

FIG. 5 shows the intersections between the self-interference signal and a pair of sinc functions centered at the boundaries of the first window of FIG. 4, in accordance with one embodiment of the present invention.

FIG. 6 shows the level of attenuations applied to the pair of signals travelling in the paths defining the first window shown in FIG. 5, in accordance with one embodiment of the present invention.

FIG. 7 shows the intersections between the self-interference signal and a pair of sinc functions centered at the boundaries of the second window of FIG. 4, in accordance with one embodiment of the present invention.

FIG. 8 shows the level of attenuations applied to the two pairs of signals travelling in the paths defining the first and second windows shown in FIG. 5, in accordance with one embodiment of the present invention.

FIG. 9 is an exemplary plot showing the relationship between the number of delay/attenuation paths and the amount of cancellation, in accordance with one embodiment of the present invention.

FIG. 10 is a flowchart for cancelling or reducing a self-interference signal, in accordance with one embodiment of the present invention.

FIG. 11 is a simplified block diagram of a full-duplex wireless communication system, in accordance with one embodiment of the present invention.

FIG. 12 is a simplified block diagram of a full-duplex wireless communication system, in accordance with one embodiment of the present invention.

FIG. 13 is a simplified block diagram of a full-duplex wireless communication system, in accordance with one embodiment of the present invention.

### DETAILED DESCRIPTION OF THE INVENTION

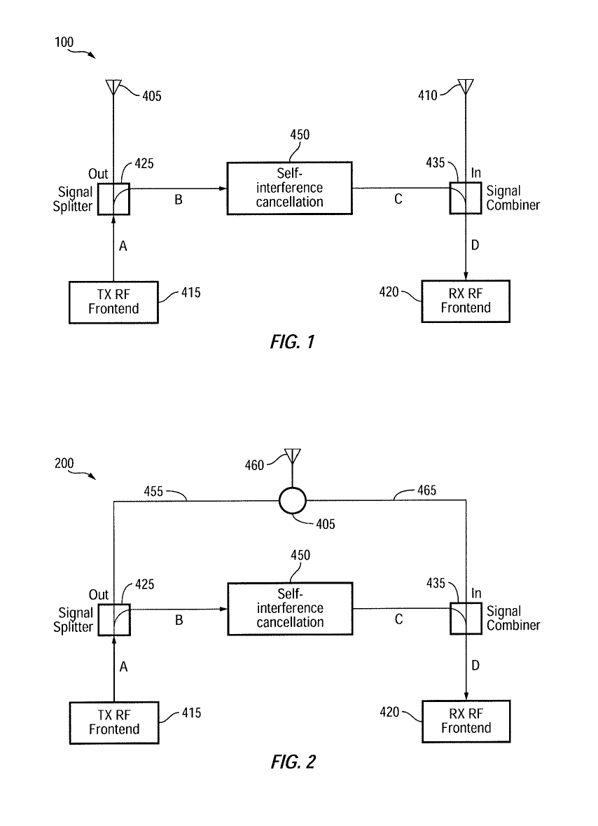

FIG. 1 is a simplified block diagram of a full-duplex wireless communication device 100, in accordance with one embodiment of the present invention. Wireless communication device 100, which may be a cellular phone, a base station, an access point or the like, is configured to transmit data/signals via transmit antenna 405 and receive data/signals via a receive antenna 410. Wireless communication device (herein alternatively referred to as device) 100 is also shown, as including, in part, a transmit front-end 415, a signal splitter 425, a receive front end 420, a signal combiner 435, and a self-interference cancellation circuit 450. Device 100 may be compatible and operate in conformity with one or more communication standards such as WiFi™, Bluetooth®, GSM EDGE Radio Access Network (“GERAN”), Universal Terrestrial Radio Access Network (“UTRAN”), Evolved Universal Terrestrial Radio Access Network (“E-UTRAN”), Long-Term Evolution (LTE), and the like.

Transmit front-end 415 is adapted to process and generate transmit signal A. Signal splitter 425 splits the transmit signal and delivers a portion (sample) of this signal, i.e., signal B, to self-interference cancellation circuit 450. The remaining portion of the transmit signal, which is relatively large (e.g., 85% of the transmit signal) is delivered to transmit antenna 405. Because the transmit and receive antenna 405 and 410 operate in substantially the same frequency band, signal IN received by receive antenna 410 includes the desired signal as well as a portion of the transmitted signal OUT. The transmitted signal component that is received by antenna 410 is an undesirable signal and is referred to hereinafter as the self-interference signal. Self-interference cancellation circuit 450 operates to reconstruct the self-interference signal—which is subsequently subtracted from the received signal IN. To achieve this, self-interference cancellation circuit 450 generates a multitude of weighted and delayed samples of the transmit signal, and combine these signals to generate signal C that is representative of the self-interference signal. Signal combiner 435 is adapted to subtract the signal it receives from self-interference cancellation circuit 450 from the signal it receives from antenna 410, thereby to deliver the resulting signal D to receive front-end 420. Accordingly, the self-interference component of the signal received by receive front-end 420 is substantially degraded. In one embodiment, self-cancellation circuit 450 may cancel, e.g., 20-25 dB of self-interference signal.

FIG. 2 is a simplified block diagram of a full-duplex wireless communication device (hereinafter alternatively referred to as device) 200, in accordance with another embodiment of the present invention. Device 200 is similar to device 100 except that device 200 has a single antenna 460 used for both transmission and reception of signals. Device 200 also includes a circulator 405 that provides isolation between its ports. Circulator 405 is adapted to concurrently deliver the transmit signal and the receive signal to and from antenna 460. In one exemplary embodiment, circulator 405 provides approximately 15 dB of isolation between the transmit and receive paths, thereby reducing the self-interference on the receive port by approximately 15 dB.

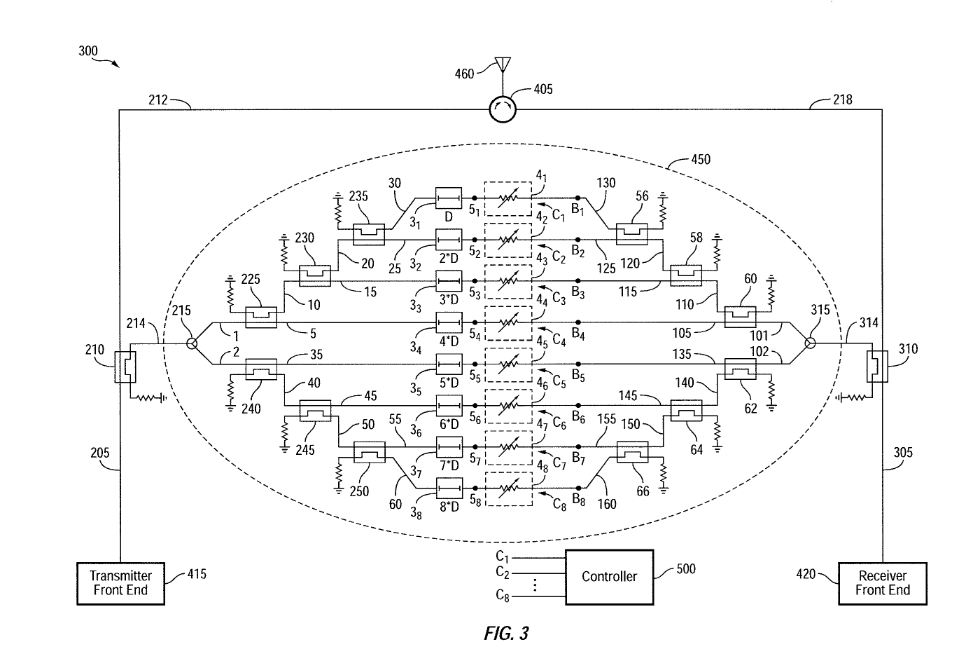

FIG. 3 is a simplified block diagram of a full-duplex wireless communication device (hereinafter alternatively referred to as device) 300, in accordance with one exemplary embodiment of the present invention. Device 300 is shown as including, in part, a transmitter front end 415, a receiver front end 420, a transmit/receive antenna 460, a circulator 405, and a self-interference cancellation circuit 450 as is also disposed in devices 100 and 200 shown in FIGS. 1 and 2 respectively. Coupler 210 receives a sample of transmit signal 205 and in response delivers a through signal 212 to circulator 450, and a coupled signal 214 to splitter 215. Self-interference signal cancellation circuit 450 is adapted to reconstruct the self-interference signal 314 from the sample of the transmit signal 214. The reconstructed self-interference signal 314 is subtracted from received signal 218 by coupler 310 thereby to recover the signal of interest 305, also referred to as the desired signal. The desired signal 305 is delivered to receiver front end 420 for further processing.

In the following, for simplicity, the same reference number may be used to identify both the path through which a signal travels, as well as to the signal which travels through that path. For example, reference numeral 5 may be used to refer to the path so identified in FIG. 3, or alternatively to the signal that travels through this path. Furthermore, in the following, the terms divider, splitter, coupler, or combiner are alternatively used to refer to an element adapted to split/divide a signal to generate more signals and/or couple/combine a multitude of signals to generate one or more signals. Such a component is also alternatively referred to herein as splitter/coupler.

Exemplary self-interference signal cancellation circuit 450 is shown as having 8 signal paths (also referred to herein as taps), namely signal paths 30, 25, 15, 5, 35, 45, 55, 60. It is understood, however, that a self-interference signal cancellation circuit, in accordance with the present invention, may have fewer or more than 8 taps and thus may have any number of even or odd taps. Signal cancellation circuit 450 is adapted to enable full duplex wireless communication by cancelling or minimizing the self-interference signal. As seen from FIG. 3, each tap includes a delay element and a variable attenuator to compensate for a range of disturbances, such as variable delay spreads.

As described above, coupler 210 receives a sample of transmit signal 205 and in response delivers a through signal 212 to circulator 405, and a coupled signal 214 to splitter 215. Signal 214 may be, for example, 10-20 dB weaker than signal 205. Splitter 215 is adapted to split signal 214 into two signals 1, and 2, which may have equal powers in one embodiment. The through and coupled output signals 212 and 214 of coupler 210 are respectively in phase and 90° out of phase with respect to signal 205.

Signal 1 is applied to coupler 225, which in response generates a through output signal 5 and a coupled output signal 10. Similarly, signal 10 is applied to coupler 230, which in response generates a through output signal 15 and a coupled output signal 20. Likewise, signal 20 is applied to coupler 235, which in response generates a through output signal 25 and a coupled output signal 30. The coupled output signal of each of couplers 225, 230 and 235 has a 90° phase shift relative to its through output signal. Accordingly, signals 5 and 10 have a 90° phase difference. Likewise, there is a 90° phase difference between signals 15, 20; and a 90° phase difference between signals 25, 30.

In a similar manner and as shown, Signal 2 is applied to coupler 240, which in response generates a through output signal 35 and a coupled output signal 40. Signal 40 is applied to coupler 245, which in response generates a through output signal 45 and a coupled output signal 50. Signal 50 is applied to coupler 250, which in response generates a through output signal 55 and a coupled output signal 60. The coupled output signal of each of couplers 240, 245 and 250 has a 90° phase shift relative to its through output signal. Accordingly, signals 35 and 40 have a 90° phase difference. Likewise, there is a 90° phase difference between signals 45, 50; and a 90° phase difference between signals 55, 60.

The coupled output of each coupler is weaker than the signal received by that coupler by a predefined dB. In one example, the coupled output of each coupler is 6 dB weaker than the signal received by that coupler. As is well known, the through output signal of each coupler is also weaker than the coupler's input signal due to an insertion loss. However, for each coupler, the through output signal is stronger than the coupled output signal. Accordingly, in the exemplary embodiment shown in FIG. 3, of the 8 signals 30, 25, 15, 5, 35, 45, 55, 60, signals 5, 35 have substantially the same phase and power and are the strongest signals; signals 15, 45 have substantially the same phase and power and are the second strongest signals; signals 25, 55 have substantially the same phase and power and are the third strongest signals; and signals 30, 60 have substantially the same phase and power and are the fourth strongest signals.

Self-interference signal cancellation circuit 450 is further shown as including eight delay elements 3₁, 3₂, 3₃, 3₄, 3₅, 3₆, 3₇, 3₈ each adapted to delay the signal it receives by a fixed amount of delay. Delay elements 3₁, 3₂, 3₃, 3₄, 3₅, 3₆, 3₇, 3₈ are adapted respectively to delay signals 30, 25, 15, 5, 35, 45, 55, 60 by different amounts of delay. For example, in the exemplary embodiment shown in FIG. 1, delay elements 3₁, 3₂, 3₃, 3₄, 3₅, 3₆, 3₇, 3₈ are adapted to delay the signals they receive respectively by D, 2D, 3D, 4D, 5D, 6D, 7D and 8D, where D is a fixed amount. In other embodiments, the delay elements may delay the signals they receive by different amounts or ratios.

Self-interference signal cancellation circuit 450 is further shown as including eight variable attenuators 4₁, 4₂, 4₃, 4₄, 4₅, 4₆, 4₇, 4₈ each adapted to attenuate the signal it receives from its associated delay element in accordance with a different attenuation signal Cᵢ, wherein i is an integer ranging from 1 to 8 in this exemplary embodiment, generated by controller 500. Accordingly, signals 130, 125, 115, 105, 135, 145, 155, 160 supplied respectively by variable attenuators 4₁, 4₂, 4₃, 4₄, 4₅, 4₆, 4₇, 4₈ (alternatively and collectively referred to herein using reference number 4) are time-delayed, weighted signal samples that are used to reconstruct the self-interference component of the transmitted signal at the receiver using a sinc function and in conformity with the sampling theory, as described further below.

In accordance with one embodiment, the control signals Cᵢ applied to variable attenuators 4₁, 4₂, 4₃, 4₄, 4₅, 4₆, 4₇, 4₈ are selected such that the weights associated with and assigned to the two center taps 5₄, 5₅ have first and second highest magnitudes, the weights associated with adjacent taps 5₃, 5₆ have third and fourth highest magnitudes, the weights associated with taps 5₂, 5₇ have fifth and sixth highest magnitudes, and the weights associated with taps 5₁, 5₈ have the seventh and eight highest magnitudes. Consequently, in accordance with such embodiments, by disposing a variable attenuator in each delay path and aggregating the responses of the delay paths, the phase offset and the variable delay spread caused by any perturbation of the transmitted signal as it arrives at the receiver may be accounted for. An algorithm, such as the gradient decent algorithm, may be used to set the attenuation level of each of the variable attenuators 4₁, 4₂, 4₃, 4₄, 4₅, 4₆, 4₇, 4₈ disposed in different delay paths via control signals Cᵢ.

As seen from FIG. 3, coupler 56 couples signal 125—received via its through input—and signal 130—received via its coupled input—to generate signal 120; coupler 58 couples signals 115 and 120 to generate signal 110; and coupler 60 couples signals 105 and 110 to generate signal 101. Likewise, coupler 66 couples signals 155 and 160 to generate signal 150; coupler 64 couples signals 145 and 150 to generate signal 140; and coupler 62 couples signals 135 and 140 to generate signal 102. Signal combiner 315 is adapted to combine signals 101, 102 to reconstruct the self-interference signal 314.

The output signal of each of couplers 56, 58, 60, 62, 64, 66 has a 90° phase difference relative to its coupled input signal and a 0° phase difference relative to its through input signal. Accordingly, for example, the signal travelling from path 1 to path 101 via paths 5, 105 does not experience a relative phase shift. However, the signal travelling from path 1 to path 101 via paths 10, 15, 115, 110 receives a first 90° phase shift while passing through coupler 225, and a second a 90° phase shift while passing through coupler 60. Therefore, path 1, 10, 15, 115, 110, 101 has a 180° phase shift relative to path 1, 5, 105, 101.

Likewise, the signal travelling from path 1 to path 101 via paths 10, 20, 25, 125, 120, 110, 101 receives a first 90° phase shift while passing through coupler 225, a second 90° phase shift while passing through coupler 230, a third 90° phase shift while passing through coupler 58, and a fourth a 90° phase shift while passing through coupler 60. In other words, the path defined by paths (alternatively and for simplicity referred to as path) 1, 10, 20, 25, 125, 120, 110 has a 360° phase shift relative to and is thus in phase with path 1, 5, 105, 101. In a similar manner, path 1, 10, 20, 30, 130, 120, 110, 101 has a 180° phase shift relative to path 1, 5, 105, 101.

Similarly, path 2, 40, 45, 145, 140, 102, has a 180° phase shift relative to path 2, 35, 135, and 102. Path 2, 40, 50, 55, 155, 150, 140, 102, has a 360° phase shift relative to and is thus in phase with path 2, 35, 135, and 102. Path 2, 40, 50, 60, 160, 150, 140, 102, has a 180° phase shift relative to path 2, 35, 135, and 102.

Since path 1, 5, 105, 101 is in phase with path 2, 35, 135, 102, taps 5₄, 5₅—associated with attenuator 4₄, 4₅—are in phase. For the reasons described above, each of taps 5₃, 5₆—associated with attenuators 4₃, 4₆—has a 180° phase shift relative to taps 5₄, 5₅; each of taps 5₂, 5₇—associated with attenuators 4₂, 4₇—is in phase with taps 5₄, 5₅; and each of taps 5₁, 5₈—associated with attenuators 4₁, 4₈—has a 180° phase shift relative to taps 5₄, 5₅. Consequently, taps 5₈, 5₇, 5₆, 5₃, 5₂, 5₁, in accordance with embodiments of the present invention, are selected so as be either in-phase or 180° out-of-phase relative to the center taps 5₄, 5₅ in an alternating manner.

The polarities resulting from the selected tap phases together with the attenuation weights supplied by the variable attenuators enable the construction of the self-interference signal 314 at the output of signal combiner 315. Coupler 310 receives the coupled input signal 314 and the through input signal 218 and in response supplies signal 305. Signal 305 is thus in phase with signal 218 but 90° out-of-phase relative to signal 314. Accordingly, the signal travelling through the path 205, 214, 314 experiences a 180° phase shift relative to the self-interference signal travelling through the path 205, 212, 218. Couplers 210, 310 thus together provide the polarity and sign reversal required to subtract the reconstructed self-interference signal 314 from signal 218 and deliver to receiver 300 signal 305 which has a substantially degraded/cancelled component of the transmitted signal.

As shown, self-interference cancellation circuit 450 receives a sample 214 of the transmit signal 205 via splitter 210. As described above, each path in self-interference cancellation circuit 450 is shown as including a delay element 3ᵢ, where i is an index varying from 1 to 8 in this exemplary embodiment, and a variable attenuator 4ᵢ. The level of attenuation of each variable attenuator 4ᵢ may be varied in accordance with a predefined algorithm implemented by controller 500. Each delay element 3ᵢ is adapted to generate a signal that is a delayed version of signal 214. Each variable attenuator 4ᵢ is adapted to attenuate the amplitude of the signal it receives in accordance with the control signal Cᵢ applied thereto by controller 500 so as to generate an attenuated (weighted) signal Bᵢ. Accordingly, signals Bᵢ are different delayed and weighted versions of signal 214. The output of combiner 315 is signal 314 representative of the self-interference component of the transmit signal. In one embodiment combiner 315 is an adder adding signals 101, 102 to generate signal 314. In other embodiments, combiner 315 may perform other arithmetic or logic functions generate signal 314.

As described above, self-interference cancellation circuit 450 is operative to reconstruct the self-interference signal from the signal values present on the multiple paths disposed between splitter 215 and combiner 315. Since both the self-interference signal and the time-delayed, weighted signals Bᵢ are samples of the same transmit signal, the reconstruction of the self-interference signal is similar to band-limited interpolation. Furthermore, since only a finite number of taps are available, a windowed interpolation is used to reconstruct signal 314. Therefore, the signal representative of the self-interference signal, in accordance with one embodiment of the present invention, is generated from signals Bᵢ that are delayed and weighted versions of the same sampled transmit signal 214.

To generate a signal representative of the self-interference signal, in accordance with one exemplary embodiment, the delays generated in each pair of associated paths disposed between splitter 215 and combiner 315 are selected such that the arrival time of the self-interference signal at subtractor 314 falls within the difference between these two delays (also referred to herein as the delay window). Accordingly, the delay generated by a first tap in each such pair of associated taps is less than the arrival time of signal 218 at subtractor 114 (the arrival time is referred to herein as T_{self}_{_{—}}ᵢₙₜ) and the delay generated by a second tap in each pair of associated taps is greater than T_{self}_{_{—}}ᵢₙₜ.

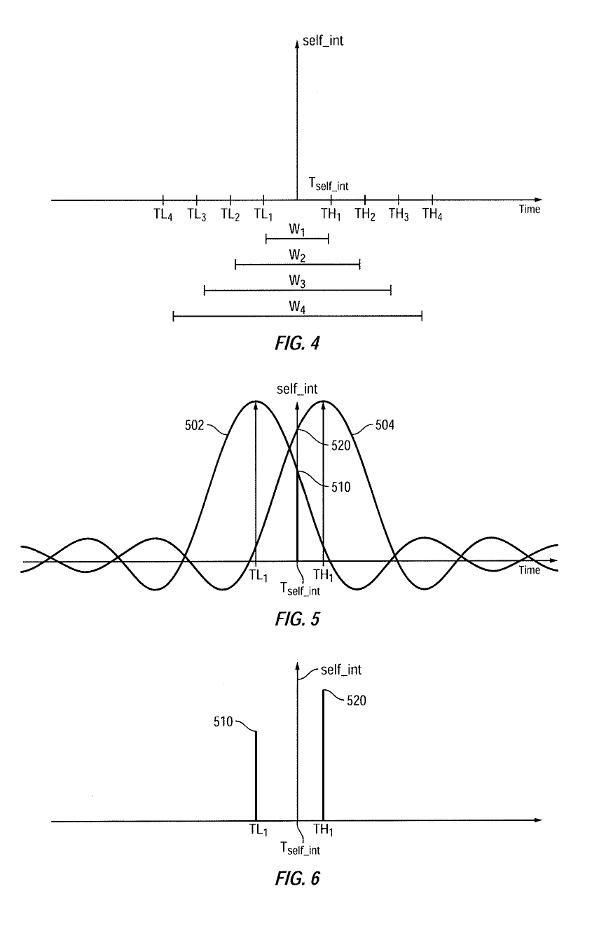

In one embodiment, the center two taps, namely taps 5₄ and 5₅, form the first pair of associated taps such that, for example, the delay TL₁ generated by delay element 3₄ is less than T_{self}_{_{—}}ᵢₙₜ and the delay TH₁ generated by delay element 3₅ is greater than T_{self}_{_{—}}ᵢₙₜ. TL₁ and TH₁ are thus selected to be the closest such delays to T_{self}_{_{—}}ᵢₙₜ. The next two taps closest to the center taps, namely taps 5₃ and 5₆, form the second pair of associated taps such that, for example, the delay TL₂ generated by delay element 3₃ is less than delay TL₁ and the delay TH₂ generated by delay element 3₆ is greater than delay TL₁; therefore TL₂ and TH₂ are selected to be the second closest such delays to T_{self}_{_{—}}ᵢₙₜ. The delays associated with the next pair of associated taps 5₂, 5₇ are selected such that, for example, the delay TL₃ generated by delay element 3₂ is less than delay TL₂ and the delay TH₃ generated by delay element 3₆ is greater than delay TL₂; therefore TL₃ and TH₃ are selected to be the third closest such delays to T_{self}_{_{—}}ᵢₙₜ. Likewise, the delays associated with the next pair of associated taps 5₁, 5₈ are selected such that, for example, the delay TL₄ generated by delay element 3₁ is less than delay TL₃ and the delay TH₄ generated by delay element 3₇ is greater than delay TL₃; therefore TL₄ and TH₄ are selected to be the fourth closest such delays to T_{self}_{_{—}}ᵢₙₜ. FIG. 4 shows the relationship between these delays. It is understood that in other embodiments, associated taps may be arranged and selected differently. For example, in another embodiment, taps 5₅ and 5₃ may be selected as associated taps and used to form a delay window.

The following description is made with reference to an arrangement according to which the center taps 5₄ and 5₅ form the first pair of associated taps, taps 5₃ and 5₆ form the second pair of associated taps, 5₂ and 5₇ form the third pair of associated taps, and taps 5₁ and 5₈ form the last pair of associated taps, as described above. Furthermore, in the following, the delays and interpolations associated with only 2 pairs of associated taps, namely associated taps 5₄/5₅ and associated taps 5₃/5₆ are described. It is understood, however, that similar operations may be performed for all other taps regardless of the number of taps disposed in a self-interference cancellation circuit in accordance with the present invention.

As shown in FIG. 4, TL₁ represents the time around which signal B₄ is generated (the delays across attenuators 4ᵢ are assumed to be negligible relative to the delays across delay elements 3ᵢ), TH₁ represents the time around which signal B₅ is generated, TL₂ represents the time around which signal B₃ is generated, and TH₂ represents the time around which signal B₆ is generated. As is seen, time delays TH₁ and TL₁ are selected—using delay elements 3₄ and 3₅—such that T_{self}_{_{—}}ᵢₙₜ falls within the window W₁ defined by the difference TH₁−TL₁. Likewise, time delays TH₂ and TL₂ are selected such that T_{self}_{_{—}}ᵢₙₜ falls within the window W₂ defined by the difference TH₂−TL₂; TH₃ and TL₃ are selected such that T_{self}_{_{—}}ᵢₙₜ falls within the window W₃ defined by the difference TH₃−TL₃, and TH₄ and TL₄ are selected such that T_{self}_{_{—}}ᵢₙₜ falls within the window W₄ defined by the difference TH₄−TL₄.

Accordingly, as described above and shown in FIG. 4, for each pair of associated taps defining a window, the amount of delay generated by one of the delay paths is longer than T_{self}_{_{—}}ᵢₙₜ, and the amount of delay generated by the other one of the delay paths is shorter than T_{self}_{_{—}}ᵢₙₜ. For example, referring to window W₁, TH₁ is greater than T_{self}_{_{—}}ᵢₙₜ and TL₁ is smaller than T_{self}_{_{—}}ᵢₙₜ. It is understood that the tap delays are selected such that T_{self}_{_{—}}ᵢₙₜ falls within a window defined by any pair of associated paths. Although the above description is provided with reference to a delay structure that includes an even number of taps, it is understood that the present invention equally applies to a delay structure with an odd number of taps. For example, a delay structure with an odd number of taps may be selected so as to position T_{self}_{_{—}}ᵢₙₜ within a time from the delay generated by the last delay path after all the other delay paths have been formed into associated pairs.

To determine the level of attenuation for each attenuator 4ᵢ, in accordance with one exemplary embodiment of the present invention, sinc interpolation is used. It is understood however that any other interpolation scheme may also be used. To achieve this, for each window, the intersection of a pair of sinc functions—each centered at one of the window boundaries and each having a peak value substantially equal to an initially estimated peak value of the self-interference signal—and the interference signal is determined. For example, referring to FIG. 5, sinc function 502 centered at TL₁ is seen as intersecting the self-interference signal Self_int at point 510, and sinc function 504 centered at TH₁ is seen as intersecting the self-interference signal Self_int at point 520. The heights of points 510 and 520 define the level of attenuations applied to attenuators 4₄ and 4₅, respectively. FIG. 6 shows the attenuation levels 510, 520 so determined and applied to attenuators 4₄ and 4₅ respectively. Furthermore, since the amplitude and delay associated with the self-interference signal Self_int may not be known in advance, the attenuation value for each attenuator may be optimized using an iterative optimization scheme to converge to an operating point of minimum measured self-interference at the receiver.

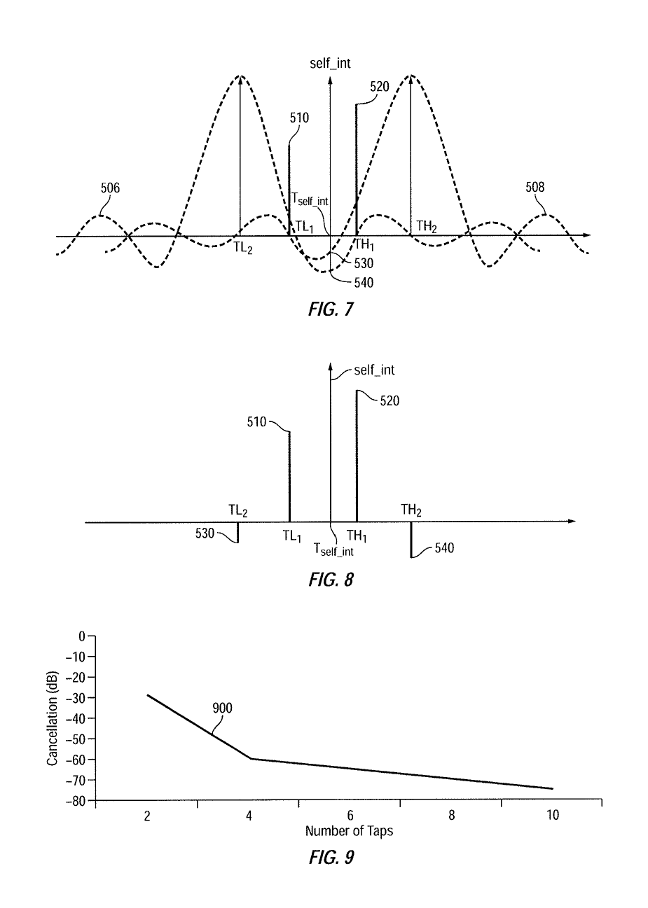

FIG. 7 shows the intersection of sinc functions positioned at the window boundaries TL₂ and TH₂ with the self-interference signal Self_int. As is seen, sinc function 506 centered at TL₂ is seen as intersecting the self-interference signal at point 530, and sinc function 508 centered at TH₂ is seen as intersecting the self-interference signal Self_int at point 540. The heights of points 530 and 540 define the level of attenuations applied to attenuators 3₃ and 3₄, respectively. FIG. 8 shows the attenuation levels 510, 520, 530, 540 so determined and applied to attenuators 3₄, 3₅, 3₃, and 3₆ respectively. As is seen in FIGS. 7 and 8, the attenuations levels applied to attenuators 3₄, 3₅ have positive values (have a positive polarity), whereas the attenuations levels applied to attenuators 3₃, 3₆ have negative values and thus have a negative polarity. It is understood that the attenuation levels for the remaining taps are similarly determined. Further details regarding the application of the sampling theory to reconstruct a sampled signal is provided in “Multirate Digital signal Processing” by Ronald E. Crochiere, and Lawrence R. Rabiner, Prentice-Hall Processing series, 1983, the content of which is incorporated herein by reference in its entirety.

The output signal 314 of combiner 315 represents a summation of signal B₁, B₂ . . . B₈ and is thus representative of the self-interference signal. As the delay of the self-interference signal changes and its position within the windows moves, the intersections of the self-interference signal and the sinc functions change, thereby causing the attenuation levels to change, which in turn causes the reconstructed signal representative of the self-cancelation signal to also change and track the self-interference signal.

The higher the number of taps, the greater is the amount of self-interference cancellation. FIG. 9 is an exemplary plot 900 of the amount of self-interference cancellation as a function of the number of taps. As is seen, the amount of self-interference cancellation for two taps and ten taps are respectively shown as being approximately −30 dB and −75 dB. In other words, by increasing the number of taps, self-interference cancellation on a wider bandwidth is achieved.

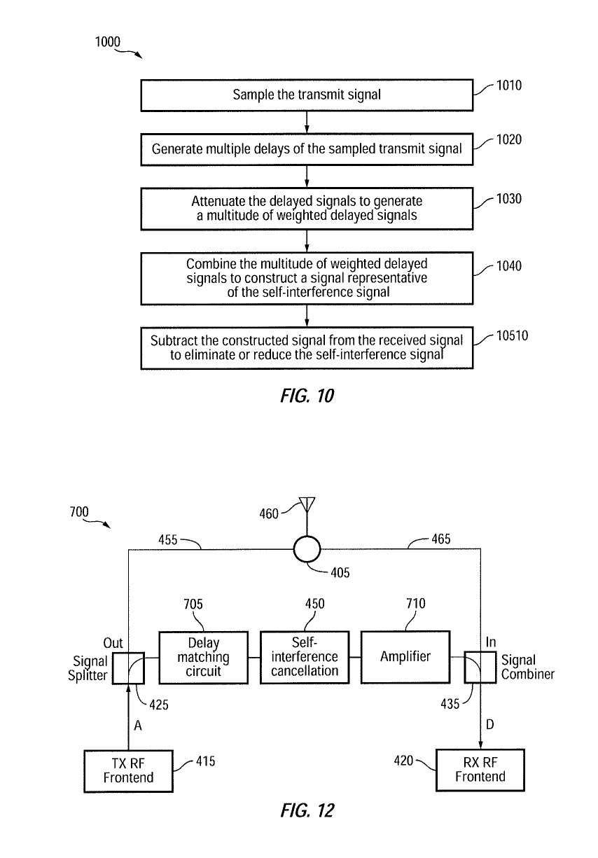

FIG. 10 shows a flowchart 1000 for canceling or reducing the self-interference signal at a receiver of a communication device, in accordance with one embodiment of the present invention. To achieve this, the transmit signal is sampled 1010. Thereafter, a multitude of delayed version of the sampled transmit signal are generated 1020. The delayed versions of the sampled transmit signal are attenuated 1030 to generate a multitude of weighted and delayed signals. The multitude of weighted, delayed signals are thereafter combined 1040 to reconstruct a signal representative of the self-interference signal. The reconstructed signal is subsequently subtracted from the received signal to cancel or reduce the self-interference signal at the receiver.

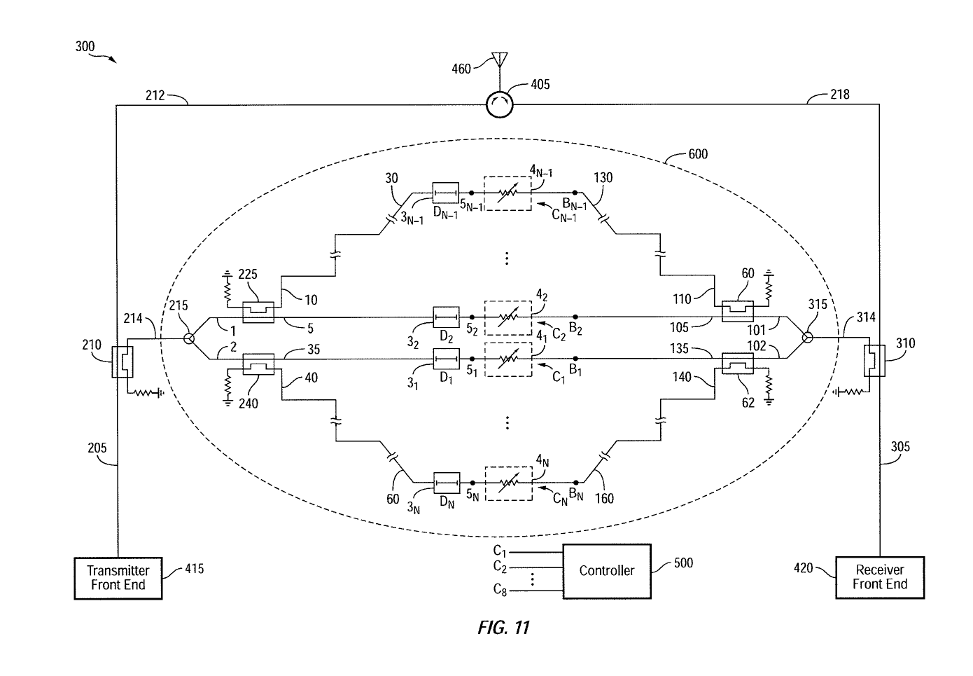

FIG. 11 is a simplified block diagram of a full-duplex wireless communication device 600, in accordance with one exemplary embodiment of the present invention. Device 600 is shown as including, in part, a transmitter front end 415, a receiver front end 420, a transmit/receive antenna 460, a circulator 405, and a self-interference cancellation circuit 650. Self-cancellation circuit 600 is similar to self-cancellation circuit 450 except that self-cancellation circuit 600 includes two center taps 5₁, 5₂ and (N−2) additional taps, where N is an integer greater than or equal to 3, and where each of the additional taps is either in phase with the two center taps, or is out-of-phase with respect to the center taps. In one embodiment, each of the additional taps is 180° out-of-phase relative to the two center taps. In yet other embodiments, a self-cancellation circuit includes only the two center taps, namely the two center taps 5₁, 5₂ of FIG. 11, and thus does not include any additional taps.

FIG. 12 is a simplified block diagram of a full-duplex wireless communication device 700, in accordance with one exemplary embodiment of the present invention. Device 700 is similar to device 200 shown in FIG. 2 except that device 700 also includes a delay matching circuit 705 and an amplifier 710. Delay matching circuit 705 is adapted to account for relatively large delay variations that may be caused by temperature variation or environmental change near the antenna. Accordingly, delay matching circuit 705 is adapted to ensure that the signal received at signal combiner 435 falls within the time windows defined to reconstruct the self-interference signal. Amplifier 710 is adapted to amplify the reconstructed self-interference signal and compensate for power loss that occurs through the self-interference cancellation circuit 450. Although delay matching circuit 705 is shown as being disposed between self-interference cancellation circuit 450 and signal splitter 425, it is understood that in other embodiments, delay matching circuit 705 may be disposed between self-interference cancellation circuit 450 and signal combiner 435. Likewise, although amplifier 710 is shown as being disposed between self-interference cancellation circuit 450 and signal combiner 435, it is understood that in other embodiments, amplifier 710 may be disposed between self-interference cancellation circuit 450 and signal splitter 425.

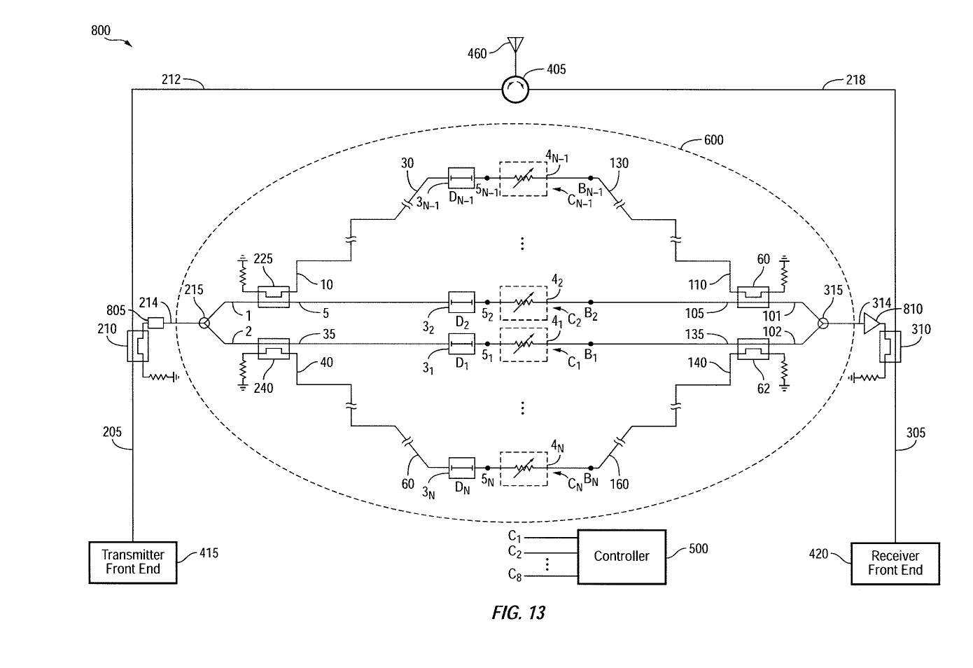

FIG. 13 is a simplified block diagram of a full-duplex wireless communication device 800, in accordance with one exemplary embodiment of the present invention. Device 800 is similar to device 600 shown in FIG. 11 except that device 800 also includes a delay matching circuit 805 and an amplifier 810. Delay matching circuit 805 is adapted to account for relatively larger delay variations that may be caused by temperature variation or environmental change near the antenna. Accordingly, delay matching circuit 705 is adapted to ensure that the signal received at coupler 310 falls within the time windows defined to reconstruct the self-interference signal, as shown for example with reference to FIG. 4. Amplifier 810 is adapted to amplify the reconstructed self-interference signal and compensate for power loss that occurs through the self-interference cancellation circuit 650. Although delay matching circuit 805 is shown as being disposed between self-interference cancellation circuit 600 and coupler 210, it is understood that in other embodiments, delay matching circuit 805 may be disposed between self-interference cancellation circuit 600 and coupler 310. Likewise, although amplifier 810 is shown as being disposed between self-interference cancellation circuit 600 and coupler 310, it is understood that in other embodiments, amplifier 810 may be disposed between self-interference cancellation circuit 600 and coupler 210. Furthermore, although not shown, in yet other embodiments, each of one or more of the signal paths in self-interference cancellation circuit 600 may include an amplifier.

The above embodiments of the present invention are illustrative and not limitative. Embodiments of the present invention are not limited by the number of taps used in the signal cancellation circuit. Embodiments of the present invention are not limited by the type of delay element, attenuator, passive coupler, splitter, combiner, amplifier, or the like, used in the cancellation circuit. Embodiments of the present invention are not limited by the number of antennas used in a full-duplex wireless communication device. Embodiments of the present invention are not limited by the frequency of transmission or reception of the signal. Embodiment of the present invention are not limited by the type or number of substrates, semiconductor or otherwise, used to from a full-duplex wireless communication device. Other additions, subtractions or modifications are obvious in view of the present disclosure and are intended to fall within the scope of the appended claims.

What is claimed is:

1. A circuit comprising:
a first signal path comprising a passive coupler, a delay element and a variable attenuator;
a second signal path comprising a passive coupler, a delay element and a variable attenuator, said second signal path being substantially in phase with the first signal path;
first P signal paths each being substantially in phase with the first and second signal paths, each of the first P signal paths comprising a delay element and a variable attenuator, each of (P−1) of the first P signal paths comprising a passive coupler; and
second M signal paths each being out-of-phase relative to the first and second signal paths, each of the second M signal paths comprising a delay element and a variable attenuator, each of (M−1) of the second M signal paths comprising a passive coupler, wherein a sum of M and P is an integer equal to or greater than one.

2. The circuit of claim 1 further comprising:
at least one antenna for receiving or transmitting a signal.

3. The circuit of claim 2 wherein each of the first signal path, the second signal path, the first P signal paths and the second M signal paths is adapted to receive a sample of a transmit signal and generate a delayed and weighted sample of the transmit signal.

4. The circuit of claim 3 further comprising:
a control block adapted to vary an attenuation level of the variable attenuators disposed in the first signal path, the second signal path, the first P signal paths and the second M signal paths;
a combiner adapted to combine the delayed and weighted samples of the transmit signal to generate a first signal representative of a self-interference signal; and
a combiner/coupler adapted to subtract the first signal from a received signal.

5. The circuit of claim 4 wherein the delay element disposed in the first signal path generates a delay shorter than an arrival time of a second sample of the transmit signal at the combiner/coupler, and wherein the delay element disposed in the second signal path generates a delay longer than the arrival time of the second sample of the transmit signal at the combiner/coupler.

6. The circuit of claim 5 wherein the first signal path, the second signal path, the first P signal paths and the second M signal paths form P/2+M/2+1 associated pairs of paths, the delays generated by the delay elements of each associated pair of delay paths forming a window within which the second sample of the transmit signal arrives at the combiner/coupler.

7. The circuit of claim 6 further comprising a controller adapted to determine the attenuation levels of the variable attenuators in accordance with values of intersections of an estimate of the self-interference signal and P+M+2 sinc functions centered at boundaries of the P/2+M/2+1 windows.

8. The circuit of claim 7 wherein a peak value of at least a subset of the P+M+2 sinc functions is set substantially equal to an amplitude of the estimate of the self-interference signal.

9. The circuit of claim 8 wherein said circuit further comprises:
a splitter adapted to generate the sample of the transmit signal from the transmit signal.

10. The circuit of claim 9 further comprising:
an isolator having a first port coupled to the antenna, a second port coupled to a transmit line of the circuit, and a third port coupled to a receive line of the circuit.

11. The circuit of claim 10 wherein said isolator is a circulator.

12. The circuit of claim 1 wherein the second M signal paths are substantially 180° of-phase relative to the first and second signal paths.

13. The circuit of claim 1 further comprising a variable delay element.

14. The circuit of claim 1 further comprising at least one amplifier.

15. A method of reducing a self-interference signal, the method comprising:
delivering a first portion of a first sample of a transmit signal to a first passive coupler to generate a first through signal;
generating a first signal defined by a delayed and weighted sample of the first through signal;
delivering a second portion of the sample of the transmit signal to a second passive coupler to generate a second through signal;
generating a second signal defined by a delayed and weighted sample of the second through signal;
generating P signals each being substantially in phase with the first and second signals and each defined by a different delayed and weighted sample of either the first or the second through signals;
generating M signals each being substantially out-of-phase relative to the first and second signals and each defined by a different delayed and weighted sample of either the first or the second through signals; and
combining the first signal, the second signal, the first P signals and the second M signals to generate a combined signal representative of the self-interference signal.

16. The method of claim 15 further comprising:
receiving a second sample of the transmit signal via an antenna;
combining/coupling the combined signal with the second sample of the transmit signal received via the antenna.

17. The method of claim 16 further comprising:
setting the delay of the first signal to a value less than an arrival time of the second sample of transmit signal at the antenna; and
setting the delay of the second signal to a value greater than the arrival time of the second sample of the transmit signal at the antenna.

18. The method of claim 17 further comprising:
forming P/2+M/2+1 associated time windows defined by the delays of the first signal, the second signal, the P signals, and the M signals; and
selecting the delays of the first signal, the second signal, the P signals, and the M signals such that the arrival time of the second sample of the transmit signal at the antenna falls within each of the P/2+M/2+1 time windows.

19. The method of claim 18 further comprising:
determining weights of the first and second though signals in accordance with values of intersections of an estimate of the self-interference signal and P+M+2 sinc functions centered at boundaries of the P/2+M/2+1 time windows.

20. The method of claim 19 further comprising:
setting a peak value of at least a subset of the P+M+2 sinc functions substantially equal to an amplitude of the estimate of the self-interference signal.

21. The method of claim 20 further comprising:
receiving the first sample of the transmit signal from a splitter.

22. The method of claim 21 further comprising:
delivering a second portion of the transmit signal to an isolator;
delivering the transmit signal from the isolator to the antenna.

23. The method of claim 22 wherein said isolator is a circulator.

24. The method of claim 15 further comprising:
generating the M signals such that each of the M signals is substantially 180° out-of-phase relative to the first and second signals.

25. The method of claim 15 further comprising:
delaying the first sample of the transmit signal.

26. The method of claim 15 further comprising:
amplifying the first sample of the transmit signal.

27. The method of claim 15 further comprising:
amplifying the combined signal.

28. The method of claim 15 further comprising:
amplifying at least one of the first signal or the second signal.

29. The method of claim 15 further comprising:
amplifying at least one of the M signals.

30. The method of claim 29 further comprising:
amplifying at least one of the P signals.

31. A signal cancellation circuit comprising N signal paths each being either in-phase or out-of-phase relative to other (N−1) signal paths, each of the N signal paths comprising a passive coupler, a delay element and a variable attenuator, wherein N is an integer greater than one.

32. The signal cancellation circuit of claim 31 wherein each of the N signal paths is either in-phase or 180° out-of-phase relative to other (N−1) signal paths.
